(19) United States
(12) Patent Application Publication
(10) Pub. No.: US 2019/0088385 A1
(43) Pub. Date: Mar. 21, 2019

(54) Tinsel Wire Structure and Manufacturing Method Thereof

(71) Applicant: Rosa CHANG, Taipei City (TW)

(72) Inventor: Rosa CHANG, Taipei City (TW)

(21) Appl. No.: 15/884,444

(22) Filed: Jan. 31, 2018

(30) Foreign Application Priority Data
Sep. 15, 2017 (CN) 201710833864.5

(51) Int. Cl. H01B 5/00; B32B 15/20; C23C 2/38; H01B 1/02; H01B 13/02; C23C 2/08; B32B 15/02; H01B 13/22

(52) U.S. Cl. CPC H01B 5/002; B32B 15/20; C23C 2/38; H01B 1/026; H01B 13/02; C23C 2/08; B32B 2311/16; H01B 13/22; B32B 2255/06; B32B 2255/205; B32B 2307/202; B32B 2311/12; B32B 15/02

(57) ABSTRACT

A tinsel wire structure and a manufacturing method thereof are provided. The tinsel wire structure has a core, a conductive layer and a metal cladding layer. The core has an outer surface and defines a length direction. The conductive layer is spirally wound along the length direction on the outer surface of the core. The metal cladding layer is provided on the periphery of the conductive layer to cover the core and the conductive layer. The conductive layer is spirally wound on the outer surface of the core in a non-overlapping manner to define a gap so that the gap is spirally wound on the outer surface of the core in a non-overlapping manner. When the metal cladding layer covers the core and the conductive layer, the metal cladding layer covers the gap at the same time.

### CROSS-REFERENCES TO RELATED APPLICATIONS

This application claims priority to Chinese Patent Application No. 201710833864.5 filed on Sep. 15, 2017.

### BACKGROUND OF THE INVENTION

### Field of the Invention

The present invention relates to a tinsel wire structure and a manufacturing method thereof, and more particularly, to a tinsel wire structure having a metal cladding layer and a manufacturing method thereof.

### Descriptions of the Related Art

Most of current electronic products support various types of wireless communication protocols and thus are capable of signal or data transmission in a wireless way. However, in actual use, the transmission quality of wireless transmission is still likely to be compromised due to factors such as insufficient transmission bandwidth, interferences from other signals or obstacles on the transmission path or the like. Therefore, transmission of signals or data in a wired way is still a transmission scheme that is frequently selected by users.

When signals or data are transmitted in a wired way, the resistance of the material of the wire selected is closely related to the transmission quality of the wire. Generally speaking, a larger resistance of the material of the wire tends to cause a larger obstacle for the transmission of the signal or the data, and thus makes it easier for the signal to be distorted or to influence the transmission speed.

Moreover, as can be known from the resistance formula of Resistance (R)=Resistance constant (p)×Length (L)/Sectional area (A), the Resistance (R) is positively proportional to the Length (L) and the Resistance (R) is inversely proportional to the Sectional area (A) when the Resistance constant (p) is a constant value. In other words, the longer the distance (i.e., the length) that the signal (or the current) travels during the transmission is, the larger the resistance is; and the smaller the sectional area that the signal (or the current) passes through during the transmission is, the larger the resistance is.

For the tinsel wire structures being used currently, the conductive layer thereof is spirally wound on a core. Therefore, when a signal (or current) is transmitted from one end of the tinsel wire structure to the other end of the tinsel wire structure, the distance (length) that the current travels through the conductive layer spirally wound is much larger than a straight line distance between the two ends of the tinsel wire structure, thereby increasing the resistance and adversely affecting the signal transmission.

On the other hand, the heat generated as the resistance increases during the transmission process will soften the conductive layer and reduce the flexibility thereof. When a tinsel wire structure of a small wire diameter (the diameter of the wire) is adopted, a small sectional area defined by the small wire diameter will result in a larger resistance. Therefore, when the tinsel wire structure operates under a relatively high operating temperature due to the high resistance and being bent for several times, the conductive layer of the tinsel wire structure is likely to be broken and thus fails the signal transmission. Therefore, such tinsel wire structures of a small wire diameter have a defect of being not resistant to bending.

Accordingly, an urgent need exists in the art to provide a tinsel wire structure which has a low impendence and is resistant to bending with a limited wire diameter.

### SUMMARY OF THE INVENTION

An objective of the present invention is to provide a tinsel wire structure and a manufacturing method thereof, which enables the tinsel wire structure to maintain a lower resistance and a higher bending-resistant characteristic while having a small wire diameter so as to meet customized requirements of different manufactures.

To achieve the aforesaid objective, a tinsel wire structure of the present invention comprises a core, a conductive layer and a metal cladding layer. The core has an outer surface and defines a length direction, the conductive layer is spirally wound along the length direction on the outer surface of the core, and the metal cladding layer is provided on the periphery of the conductive layer to cover the core and the conductive layer. The conductive layer is spirally wound on the outer surface of the core in a non-overlapping manner to define a gap so that the gap is spirally wound on the outer surface of the core in a non-overlapping manner, and when the metal cladding layer covers the core and the conductive layer, the metal cladding layer covers the gap at the same time.

To achieve the aforesaid objective, a manufacturing method of a tinsel wire structure according to the present invention comprises the following steps of: step S1: providing a core that has an outer surface and defines a length direction; step S2: spirally winding a conductive layer along the length direction of the core on the outer surface of the core; and step S3: forming a metal cladding layer on the periphery of the conductive layer to cover the core and the conductive layer; wherein the conductive layer is spirally wound on the outer surface of the core in a non-overlapping manner to define a gap so that the gap is spirally wound on the outer surface of the core in a non-overlapping manner, and when the metal cladding layer covers the core and the conductive layer, the metal cladding layer covers the gap at the same time.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a tinsel wire structure that has not yet been provided with a metal cladding layer according to the present invention;

FIG. 2 is a schematic view of a tinsel wire structure that has been provided with a metal cladding layer according to the present invention;

FIG. 3 is a cross-sectional view of the tinsel wire structure of FIG. 2;

FIG. 4 is a partial and enlarged schematic view of a portion circled in FIG. 3; and

FIG. 5 is a view illustrating steps of a manufacturing method of a tinsel wire structure according to the present invention.

### DESCRIPTION OF THE PREFERRED EMBODIMENT

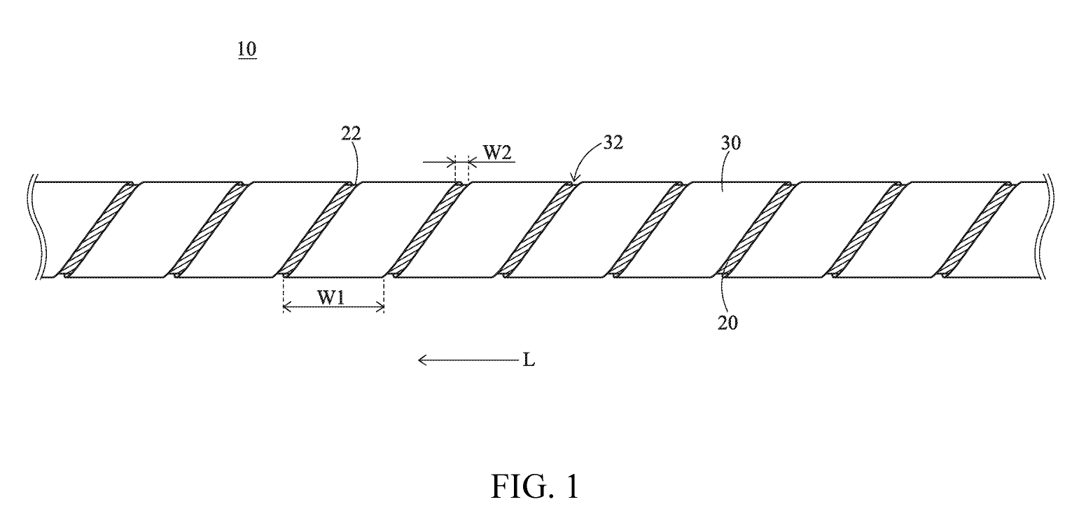

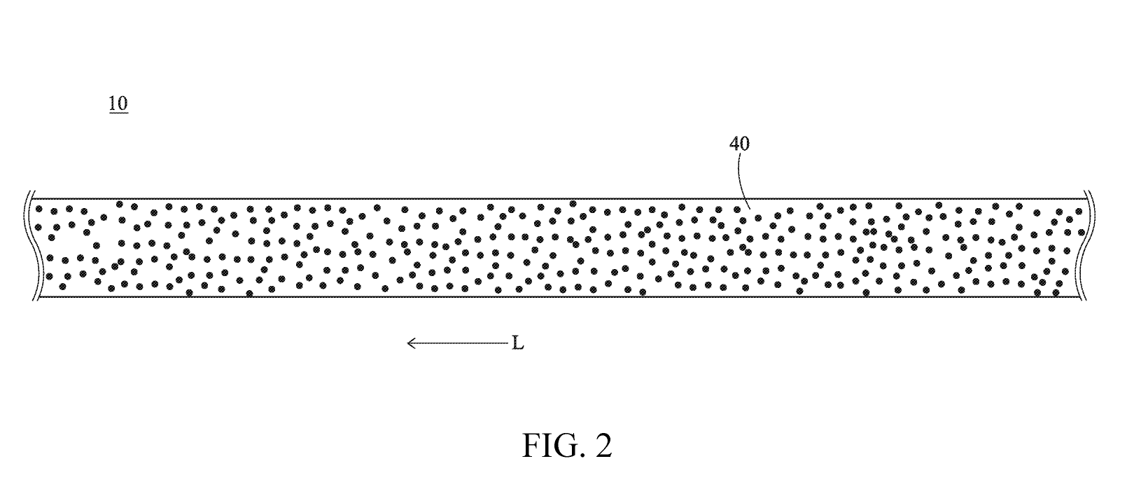

As shown in FIG. 1 and FIG. 2, a tinsel wire structure 10 of the present invention comprises a core 20, a conductive layer 30 and a metal cladding layer 40 so that it is capable of signal (or current) transmission.

As shown in the embodiment of FIG. 1, the core 20 has an outer surface 22 and defines a length direction L, the conductive layer 30 is spirally wound along the length direction L on the outer surface 22 of the core 20, and as shown in FIG. 2, the metal cladding layer 40 is provided on the periphery of the conductive layer 30 to cover the core 20 and the conductive layer 30 so that the tinsel wire structure 10 has a complete appearance.

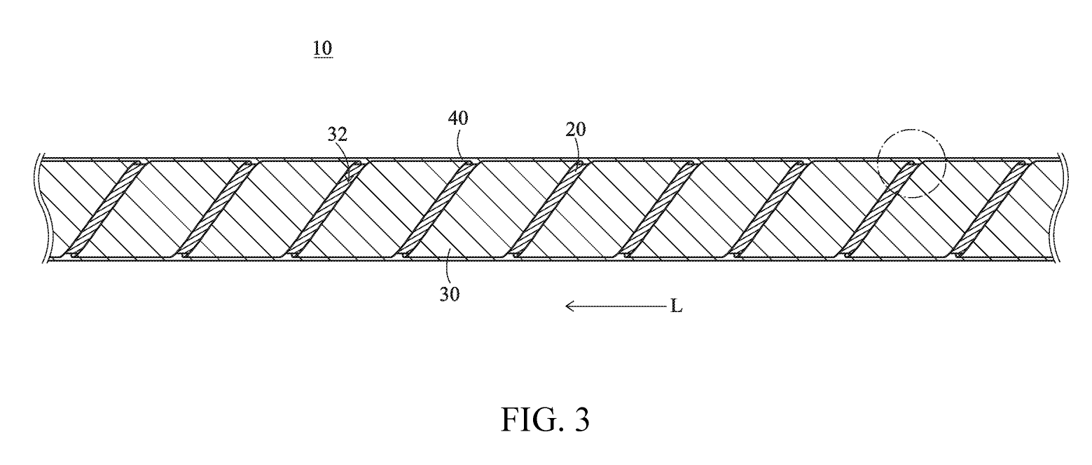

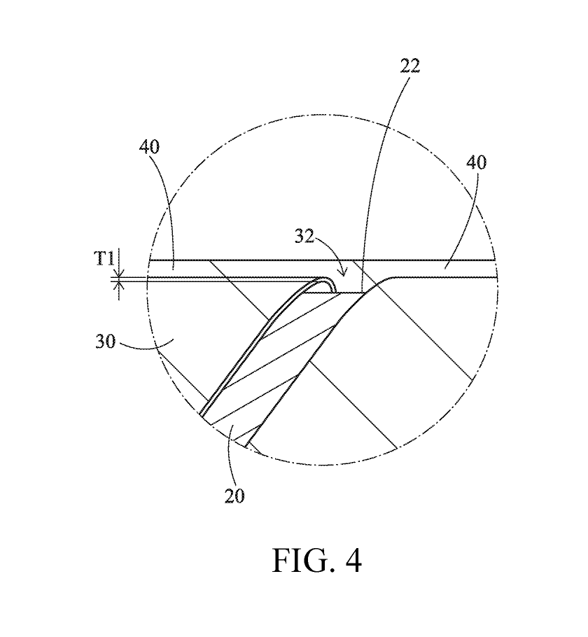

In detail, as shown in cross-sectional views of FIG. 3 and FIG. 4 (wherein FIG. 4 is depicted in an exaggerated scale to clearly show the structure of the tinsel wire structure 10), the conductive layer 30 of the tinsel wire structure 10 is spirally wound on the outer surface 22 of the core 20 in a non-overlapping manner, and thus a gap 32 may be defined so that the gap 32 is spirally wound on the outer surface 22 of the core 20 in a non-overlapping manner. Moreover, when the metal cladding layer 40 covers the core 20 and the conductive layer 30, the metal cladding layer 40 may cover the gap 32 at the same time so that the gap 32 is not exposed.

In the tinsel wire structure 10 of the present invention, the core 20 is a fibrous core so that the core 20 has a characteristic of being resistant to high temperature and bending, while the conductive layer 30 is a metal foil. Still referring to FIG. 1, the metal foil as the conductive layer 30 defines a first width W1 along the length direction L, the gap 32 defines a second width W2 along the length direction L, and a ratio of the first width W1 to the second width W2 ranges between 10:1 and 15:1. By defining the ratio of the first width W1 to the second width W2 in the aforesaid way, it can be ensured that the metal cladding layer 40 can really cover the gap 32 when the metal cladding layer 40 covers the core 20 and the conductive layer 30 so that the gap 32 will not be exposed from the metal cladding layer 40, thereby ensuring that the metal cladding layer 40 can achieve the electromagnetic wave shielding effect.

In a preferred embodiment of the present invention, as shown in FIG. 4, the metal foil forming the conductive layer 30 has a thickness ranging between 0.01 mm and 0.05 mm to ensure that a total wire diameter of the tinsel wire structure 10 according to the present invention can be maintained in a relatively thin range. Additionally, the metal foil of the present invention is a copper alloy foil, and the copper alloy foil is a tin-copper alloy foil, a silver-copper alloy foil or an iron-copper alloy foil.

In order to make the metal cladding layer 40 provided on the periphery of the tinsel wire structure 10 really and completely cover the core 20, the conductive layer 30 and the gap 32, the metal cladding layer 40 of the present invention is provided to cover the periphery of the conductive layer 30 through a hot dipping process, and a liquid metal used in the hot dipping process is liquid tin.

Therefore, as shown in FIG. 4, the metal cladding layer 40 formed through the hot dipping process can really cover the gap 32 in appearance under a micro-status so that the gap 32 is not exposed. In this way, when a signal (or current) is transmitted from the right end to the left end of the tinsel wire structure 10, the signal can be transmitted directly from an end (i.e., the right end) of the gap 32 to the other end (i.e., the left end) of the gap 32 when the signal encounters the gap 32 by the arrangement of the metal cladding layer 40, thereby avoiding the spirally wound path that the signal travels during the transmission thereof in the prior art, and greatly reducing the transmission distance of the signal.

On the other hand, after the transmission path of the signal is reduced, the heat generated during the transmission process will accordingly be reduced so that the tinsel wire structure 10 of the present invention may also have the following advantage of: being capable of effectively preventing the softening of the conductive layer 30 and increasing the flexibility thereof.

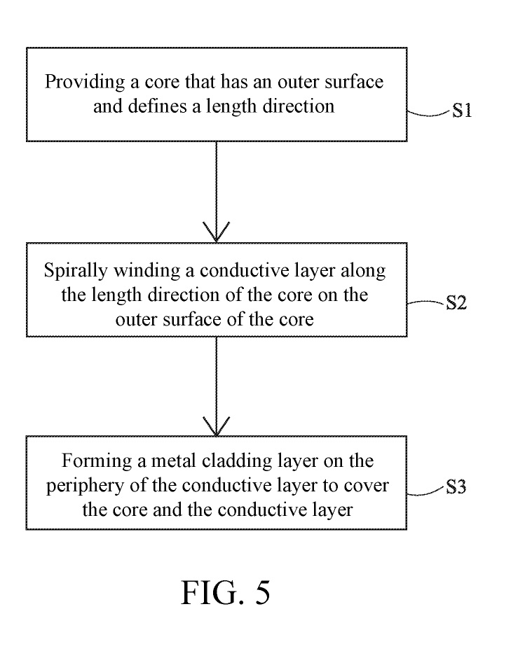

As shown in FIG. 5, the present invention further provides a manufacturing method of the tinsel wire structure 10 which comprises the following steps of: first providing a core 20 that has an outer surface 22 and defines a length direction L, as shown in step S1; spirally winding a conductive layer 30 along the length direction L of the core 20 on the outer surface 22 of the core 20, as shown in step S2; and finally forming a metal cladding layer 40 on the periphery of the conductive layer 30 to cover the core 20 and the conductive layer 30, as shown in step S3. The conductive layer 30 is spirally wound on the outer surface 22 of the core 20 in a non-overlapping manner to define a gap 32 so that the gap 32 is spirally wound on the outer surface 22 of the core 20 in a non-overlapping manner accordingly, and when the metal cladding layer 40 covers the core 20 and the conductive layer 30, the metal cladding layer 40 may cover the gap 32 at the same time so that the gap 32 will not be exposed.

Like the above description of the tinsel wire structure 10, in the manufacturing method of the tinsel wire structure 10, the core 20 is a fibrous core so that the core 20 has a characteristic of being resistant to high temperature and bending, while the conductive layer 30 is a metal foil. The metal foil for forming the conductive layer 30 is preferably a copper alloy foil, and the copper alloy foil is a tin-copper alloy foil, a silver-copper alloy foil or an iron-copper alloy foil.

On the other hand, in order to make the metal cladding layer 40 provided on the periphery of the tinsel wire structure 10 really and completely cover the core 20, the conductive layer 30 and the gap 32, the metal cladding layer 40 of the present invention is provided to cover the periphery of the conductive layer 30 through a hot dipping process, and a liquid metal used in the hot dipping process is liquid tin.

According to the above descriptions, by the arrangement of the metal cladding layer in the tinsel wire structure and a manufacturing method thereof disclosed in the present invention, the signal can be transmitted in a nearly linear manner, thereby reducing the generation of waste heat and effectively preventing the softening of the conductive layer to increase the flexibility thereof. Furthermore, the metal cladding layer provided through the hot dipping process can also effectively avoid the increase in the overall wire diameter of the tinsel wire structure so that the overall wire diameter of the tinsel wire structure still remains at a relatively small size to meet customized requirements of different manufacturers.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A tinsel wire structure, comprising:
a core, having an outer surface and defining a length direction;
a conductive layer, spirally wound along the length direction on the outer surface of the core; and
a metal cladding layer, being provided on a periphery of the conductive layer to cover the core and the conductive layer;
wherein the conductive layer is spirally wound on the outer surface of the core in a non-overlapping manner to define a gap so that the gap is spirally wound on the outer surface of the core in a non-overlapping manner, and when the metal cladding layer covers the core and the conductive layer, the metal cladding layer covers the gap at the same time.

2. The tinsel wire structure of claim 1, wherein the core is a fibrous core, and the conductive layer is a metal foil.

3. The tinsel wire structure of claim 2, wherein the metal foil defines a first width along the length direction, the gap defines a second width along the length direction, and a ratio of the first width to the second width ranges between 10:1 and 15:1.

4. The tinsel wire structure of claim 2, wherein the metal foil has a thickness ranging between 0.01 mm and 0.05 mm.

5. The tinsel wire structure of claim 2, wherein the metal foil is a copper alloy foil.

6. The tinsel wire structure of claim 5, wherein the copper alloy foil is a tin-copper alloy foil, a silver-copper alloy foil or an iron-copper alloy foil.

7. The tinsel wire structure of claim 1, wherein the metal cladding layer is provided on the periphery of the conductive layer through a hot dipping process.

8. The tinsel wire structure of claim 7, wherein a liquid metal used in the hot dipping process is liquid tin.

9. A manufacturing method of a tinsel wire structure, comprising the following steps:
providing a core that has an outer surface and defines a length direction;
spirally winding a conductive layer along the length direction of the core on the outer surface of the core; and
forming a metal cladding layer on a periphery of the conductive layer to cover the core and the conductive layer;
wherein the conductive layer is spirally wound on the outer surface of the core in a non-overlapping manner to define a gap so that the gap is spirally wound on the outer surface of the core in a non-overlapping manner, and when the metal cladding layer covers the core and the conductive layer, the metal cladding layer covers the gap at the same time.

10. The manufacturing method of claim 9, wherein the core is a fibrous core, and the conductive layer is a metal foil.

11. The manufacturing method of claim 10, wherein the metal foil is a copper alloy foil.

12. The manufacturing method of claim 11, wherein the copper alloy foil is a tin-copper alloy foil, a silver-copper alloy foil or an iron-copper alloy foil.

13. The manufacturing method of claim 9, wherein the metal cladding layer is provided on the periphery of the conductive layer through a hot dipping process.

14. The manufacturing method of claim 13, wherein a liquid metal used in the hot dipping process is liquid tin.
